(19) United States
(12) Patent Application Publication
(10) Pub. No.: US 2014/0068220 A1
(43) Pub. Date: Mar. 6, 2014

(54) HARDWARE BASED MEMORY ALLOCATION SYSTEM WITH DIRECTLY CONNECTED MEMORY

(71) Applicants: Michael J. Osborn, Hollis, NH (US); David E. Mayhew, Northborough, MA (US); Mark D. Hummel, Franklin, MA (US)

(72) Inventors: Michael J. Osborn, Hollis, NH (US); David E. Mayhew, Northborough, MA (US); Mark D. Hummel, Franklin, MA (US)

(73) Assignee: ADVANCED MICRO DEVICES, INC., Sunnyvale, CA (US)

(21) Appl. No.: 13/605,150

(22) Filed: Sep. 6, 2012

(51) Int. Cl. G06F 12/02

(52) U.S. Cl. 711/170; 711/E12.002

(57) ABSTRACT

A hardware based memory allocation system in a computer includes: a memory module formatted with memory blocks; an input controller, in communications with the memory module and receiving a transfer request from a requestor, for transferring data from a source to the memory module; an output controller, in communications with the memory module and the input controller, for transferring data from the memory module to a destination; and a block allocator, in communications the input controller and the output controller, for maintaining a Block Descriptor Index (BDI) of Free List (FL) Addresses, each FL address pointing to a Block Descriptor Page (BDP) having a plurality of Memory Block (MB) addresses, each MB address pointing to a free memory block in the memory module.

### FIELD OF THE INVENTION

The present invention relates generally to a hardware based memory allocation system with directly connected memory, and more specifically, to a hardware based memory allocation system that efficiently manages memory blocks associated with a high-capacity, multi-channel memory across a large number of requestors for memory data transfer.

### BACKGROUND

Computer systems are used on a personal level and on a commercial level such as in data centers which are generally large centralized facilities of computer systems that provide Internet and/or intranet services supporting businesses and organizations. A typical data center can house various types of electronic equipment, such as computer systems, domain name system (DNS) servers, network switches, routers, and data storage devices. A typical data center can have hundreds or thousands of interconnected servers communicating with each other and external devices via a switching architecture comprising the switches and routers. Conventional data centers can also be configured for virtualization, permitting servers or the like to share network interface cards (NICs), hard disk drives, or other hardware. A complex switch fabric can facilitate communications between the servers.

Data transfer requests between computers are typically implemented in a formatted unit of data called a data packet carried by a packet mode computer network which is standard in today's operating systems and networks. When data is transferred between devices, it is necessarily stored for some period of time into one or more memory devices.

Computer systems store, manipulate and transfer data in memory devices such as, but not limited to, random access memory (RAM), dynamic random access memory (DRAM), static random access memory (SRAM), through-silicon via (TSV), etc.

Conventional data transfer and memory allocation is provided by software algorithms specific to the particular operating system, memory type and application requirement. These software algorithms tend to become very complex, expensive, relatively slow, difficult to trouble-shoot, and consuming extensive processing time and resources especially when attempting to manage memory blocks within a high capacity multi-channel memory across a large number of data requestors.

### BRIEF SUMMARY OF EMBODIMENTS

Certain aspects and embodiments of the invention provide a hardware based memory allocation system with directly connected memory to optimize (i.e., improve under certain conditions) the allocation and transfer of data to and from memory and improving overall speed, reliability and performance of computer systems.

Certain aspects and embodiments of the present invention provide a hardware based memory allocation system with directly connected memory for facilitating data transfer without the requirement of a software algorithm.

In accordance with an aspect, provided in one embodiment is a hardware based memory allocation system in a computer including: a memory module formatted with memory blocks; an input controller, in communications with the memory module and receiving a transfer request from a requestor, for transferring data from a source to the memory module; an output controller, in communications with the memory module and the input controller, for transferring data from the memory module to a destination; and a block allocator, in communications the input controller and the output controller, for maintaining a Block Descriptor Index (BDI) of Free List (FL) Addresses, each FL address pointing to a Block Descriptor Page (BDP) having a plurality of Memory Block (MB) addresses, each MB address pointing to a free memory block in the memory module.

In accordance with another aspect, provided in a further embodiment is a computer memory allocation method including the steps of: receiving a request from a requestor to transfer data from a source to a memory module formatted with memory blocks; transferring data from the source to the memory module according to instructions from an input controller; and communicating a location of a free memory block in the memory module according to a Block Descriptor Index (BDI) of Free List (FL) Addresses, each FL address pointing to a Block Descriptor Page (BDP) having a plurality of Memory Block (MB) addresses, each MB address pointing to a free memory block in the memory module, wherein the BDI and BDP are maintained by a block allocator in communications with the input controller and an output controller.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a hardware based memory allocation system with directly connected memory in accordance with the principles of the invention;

FIG. 2 is a diagram illustrating the operation of the block allocator in accordance with the principles of the invention; and

FIG. 3 is a diagram further detailing the operation of the block allocator in accordance with the principles of the invention.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

In order to efficiently manage highly parallel, multi-channel memory with a large number of requestors for memory data transfer, a block allocator (BA) is located at a central location and preferably associated with memory controller logic. The memory, which may be organized as discrete memory accessible through multiple channels, is divided into blocks of a fixed size, where the size is implementation specific and chosen to maximize overall efficiency. In order to efficiently allocate blocks to requestors the BA maintains a block of block pointers called the Block Description Page (BDP), as well as a block of pointers that indicate a location of each BDP called the Block Descriptor Index (BDI).

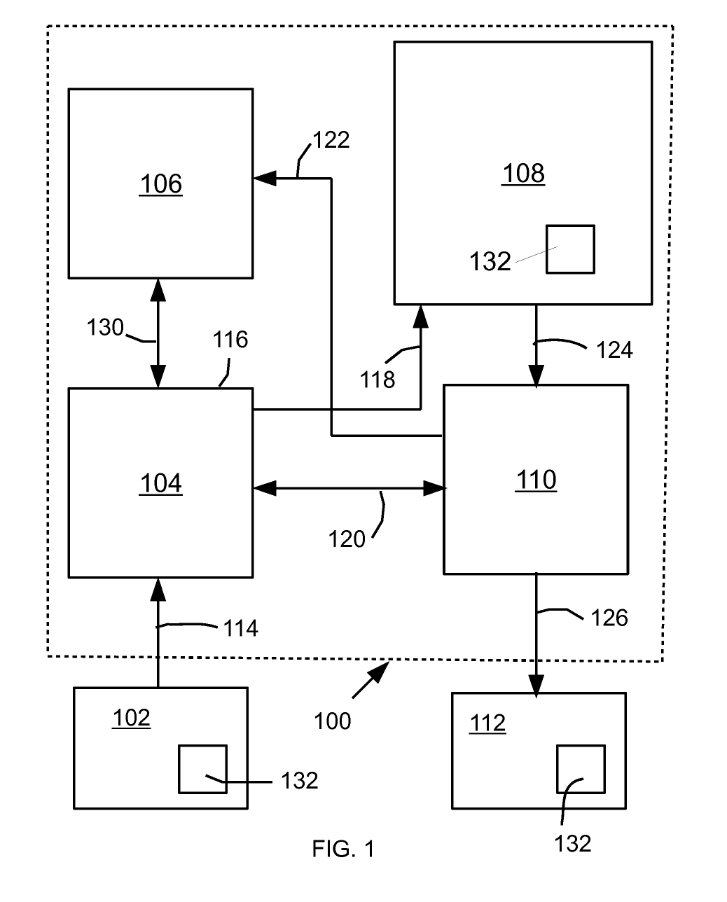

FIG. 1 is a block diagram of a hardware based memory allocation system 100 which receives data packets 132 from a source 102 for storage into a memory module 108, and which transfers data packets 132 that have been stored in the memory module 108 to a destination device 112. The memory allocation system 100 may be resident in any device or system requiring memory such as a computer system, controllers for various devices, servers for networks, the Internet, LAN and other intranet systems, etc.

The system 100 includes: a memory module 108; an input controller 104 connected via line 118 to the memory module 108 and via line 114 to a source 102 in order to receive a request from a requestor device (not shown) and to receive data from the source 102. The system 100 also includes an output controller 110 connected via line 126 to the destination device 112, via line 120 to the input controller 104 and via line 124 to the memory module 108 for transferring data from the memory module 108 to the destination device 112; and a block allocator 106 connected via line 130 to the input controller 104 and via line 122 to the output controller 110.

The memory module or other storage device 108 contains memory such as, but not limited to, TSV, RAM, SRAM, DRAM etc. Note that the memory module storage device 108 may be any type of data storage device whether long term or transient and whether labeled as memory, a switch, or any other device which holds data for some length of time. For consistency, we will refer to the storage device as memory module 108.

Organization of the data in memory is provided by formatting the memory into application specific sized memory blocks according to the needs of a given application. A memory pool, or a fixed size memory block allocation, allows dynamic memory allocation whereby memory block sizes are preallocated for optimization of particular data transfer applications to and from the memory module 108.

An allocated memory block is typically represented with a handle and an access pointer to the allocated memory. The handle can be divided into a pool index, a memory block index and a version. The pool and memory block index allow fast access to the corresponding memory block with the handle, while the version, which is incremented at each new allocation, allows detection of handles whose memory block is already freed. Additionally, memory pools of memory blocks allow memory allocation with constant execution time and no fragmentation, and fixed-size memory pools of memory blocks do not need to store allocation metadata for each allocation, describing characteristics like the size of the allocated memory block.

The memory block allocator 106 of the present invention shown in FIG. 1 keeps track of addresses of free memory blocks in the memory module 108. The block allocator 106 is a hardware device which is instrumental particularly in writes from the memory module 108. Large streams of data are managed by the block allocator 106 which may cycle the memory writes throughout all channels in memory in order to maintain a large bandwidth for all data, in the form of data packets, stored in memory. This is especially useful with memory implementations with multiple or a large number of channels (such as TSV DRAM). This distribution of data across all memory channels also contributes to longevity of use of the memory module, by minimizing and distributing wear due to multiple data reads and writes. In addition to channel distribution maintaining a large bandwidth, the block allocator can also distribute blocks within a channel to further reduce component wear, thus increasing the life of the part.

The requestor for moving or transferring data to, from, or through the hardware based memory allocation system 100 simply makes a request by way of the input controller 104. Once the data transfer request is made, the requestor does not receive any specific information about the transfer operation since the transfer of data is performed strictly at a hardware level.

A request for data to be saved into memory or retrieved from memory is initiated with the requestor device such as the source device 102 in FIG. 1 and it could be any device, user or program seeking to store or retrieve data to/from memory, such as but not limited to a computer, server, user, programmed request in an external device, etc.

The requested information is typically formatted for transfer as a data packet 132 which is a formatted unit of data carried by a packet mode computer network, standard in today's operating systems and networks. A data packet 132 consists of two kinds of data: control data and user data also know as payload data. The control data provides data that the network needs to deliver the payload data, for example, source and destination addresses, error detection codes like checksums, and sequencing information. Typically control data is found in packet headers and trailers, with payload data packed in between. Different communications protocols use different conventions for distinguishing between the elements and for formatting the data. In Binary Synchronous Transmission, the packet is formatted in 8-bit bytes, and special characters are used to delimit the different elements. Other protocols like Ethernet, establish the start of the header and data elements by their location relative to the start of the packet. Some protocols format the information at a bit level instead of a byte level.

Data Transfer from a Source Device

The input controller 104 first receives a request from the requestor device, which in this case is the source 102, to send data to memory for storage. At least in the switch the request is really to just move data, and the memory is hidden from the requestor. Any number of data packets 132 could be transferred from one or more sources 102 to one or more memory devices 108 and further to one or more destination devices 112. Also, all communications between components of the system 100, and with externally located sources and destinations, could be either hard-wired or wireless.

The block allocator 106, along with the input controller 104 and the output controller 110, control the data flow to and from the memory module 108. After the input controller 104 receives the request via connector 114 for transferring data either to the memory module 108 for storage, or to the destination device 112, then the input controller 104 sends a request via connector 130 to the block allocator 106 for a list of free memory block addresses in the memory module 108. The block allocator 106 keeps track of all free memory blocks in the memory module 108, keeping track of all free memory blocks available for use.

In the alternative, it may improve speed and efficiency if the output controller 110 releases memory blocks that have been freed up back to the input controller 104 rather than to the block allocator. Also, the input controller 104 may request a list of free memory block addresses available in the memory module 108 prior to receiving any specific external request for data transfer in order to improve performance. By pre-fetching of a list of free memory blocks or by maintaining a full list of free memory block addresses at all times, the input controller 104 will reduce the number of requests to the block allocator 106, thus increasing overall speed and efficiency.

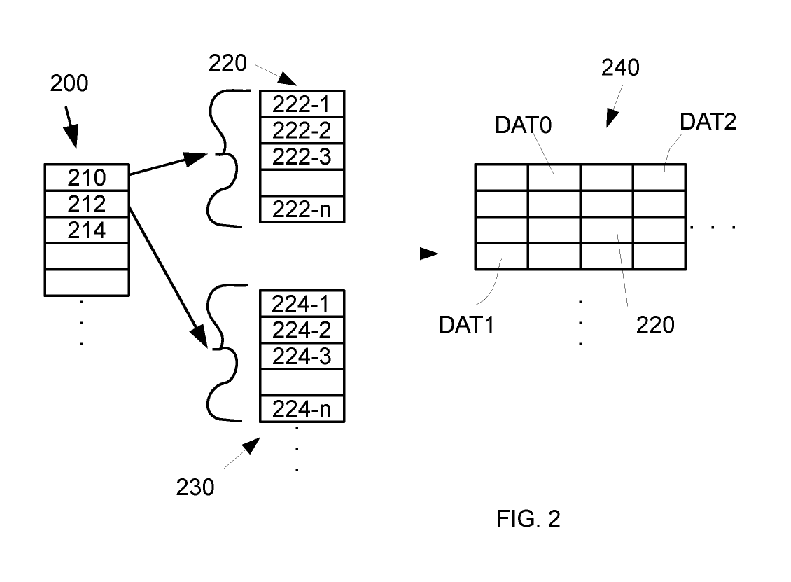

FIG. 2 is a block diagram illustrating how the block allocator 106 coordinates and controls block allocation of memory blocks 240 located in the memory module 108 (see FIG. 1). The block allocator 106 maintains a block descriptor index (BDI) 200 which is a list of free block addresses, 210, 212, 214, etc. Each of these free list block addresses, respectively, points to a block descriptor page (BDP) in memory which, in turn, contains a list of free memory block addresses. For example, BDI 210 points to BDP 220, BDI 212 points to BDP 230, etc.

Block descriptor page 220 is located in the memory module 108 and contains a list of free memory block addresses 222-1, 222-2, 222-3 to 222-n (where n is a positive integer); block descriptor page 230 also located in memory module 108 contains a list of free memory block addresses 224-1, 224-2, 224-3 to 224-n; etc. Free memory block address 222-1 points to free memory block DAT0, free memory block address 222-1 points to free memory block DAT1, free memory block address 222-3 points to free memory block DAT2, etc. As shown in FIG. 2, these free memory blocks will likely be scattered throughout memory rather than being adjacent to one another.

Typically the data packet 132 (FIG. 1) contains sufficient data to require storage in numerous memory blocks in the memory module 108. Thus it is advantageous to link the memory blocks related to a given data packet 132 by supplying a next address in each memory block. For example using FIG. 2 and assuming a data packet 132 requiring 16 memory blocks of a predetermined size, the data packet 132 can be stored by allocating 16 free memory blocks DAT0-DAT15 in the memory module 108. The first memory block DAT0 includes a next address NXT=Addr0 pointing to the second memory block DAT1 of the stored data packet 132, which in turn includes a next address NXT=Addr1 pointing to the third memory block DAT2. This procedure continues until all data of the data packet 132 has been stored in the 16 memory blocks DAT0-DAT15 within memory module 108. Note that in each memory block, the address NXT of the next memory block in the string is updated until a final memory block is reached where NXT=done indicates that the last block has been reached for the data packet. This improves read time and complexity as it limits the required communication/coordination between input and output controllers.

Once the input controller 104 receives the list of free memory blocks available in the memory module 108 from the block allocator 106 via connector 130, then the block allocator 106 would likely remove them from its list. The input controller 104 will write data from data packets 132 received via connector 114 from the source 102 to the memory blocks, allocated by the block allocator 106, in the memory module 108 via connector 118. After the data is transferred, the block allocator 106 will remove the blocks where the newly transferred data resides in memory from its free block address list in the BDI.

Data Transfer to a Destination Device

The input controller 104 first receives a request from the requestor device to transfer data from memory to a destination device. Either a single or multiple data packets 132 can be transferred from one or more memory devices 108 to one or more destination devices 112. The input controller 104 first informs the output controller 110 via connector 120 that a request has been made to retrieve data from memory, and then sends the starting address in memory of the requested data. The procedure is similar to the input operation described above.

If a request is made to retrieve a data packet 132 from the memory module 108 whereby the data packet is stored in 16 memory blocks DAT0-DAT15, then the output controller 110 will first read the DAT0 which includes the next address NXT=Addr0 pointing to DAT1. DAT1 includes a pointer to the next address NXT=Addr1, DAT2 includes a pointer to the NXT=Addr2, etc. until the complete data packet 132 is reassembled. After reassembly the output controller 110 transfers the reassembled data packet 132 via connector 126 to the destination device 132 as shown in FIG. 2. The output controller 110 also notifies the block allocator 106 of the transfer and the block allocator 106 will update its BDI free list addresses to include the recently transferred memory blocks. The output controller 110 either notifies the block allocator 106 of each memory block from which data is read, or creates its own index of block addresses from which data is read, then sends a pointer to the block allocator 106. It is also possible for the output controller 110 to release block descriptor pages of memory block addresses from which data was read back to the input controller 104 in order to minimize the involvement of the block allocator 106 which would have to consume some memory bandwidth to maintain the lists. This may provide for better memory usage/efficiency at the cost of limiting the block spreading to reduce wear on the memory.

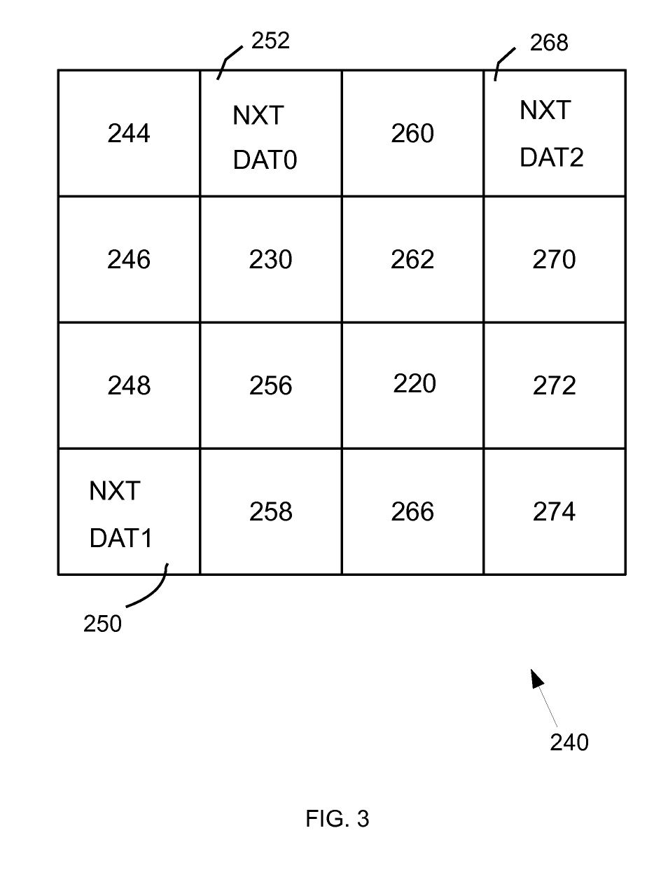

Further detail of the memory block allocation operation is apparent in view of FIG. 3 along with the following explanation.

The memory within the memory module 108 is formatted into memory blocks 240 which are individually labeled in FIG. 3 as memory blocks 244, 246, 248, 250, 252, 230, 256, 258, 260, 262, 220, 266, 268, 270, 272 and 274. Each free list address in the BDI points to a BDP in memory. For instance as shown in FIG. 2, free list address 210 points to BDP 220 and free list address 212 points to BDP 230. BDPs 220 and 230 are also shown as memory blocks in FIG. 3.

In FIG. 3, a first free list address FLAddrO (corresponding to free list address 210 in FIG. 2) points to a first BDP stored in memory block 220. A second free list address FLAddr1 (corresponding to free list address 212 in FIG. 212) points to a second BDP stored in memory block 230, and a third free list address FLAddr2 points to a third BDP stored in memory block 264. Each of the memory blocks 220, 230 and 264, respectively, contains a list of free memory block addresses such as 222-1, 222-2, 222-3 to 222-n (where n is a positive integer) illustrated in FIG. 2.

In this example, the first free memory block address listed in memory block or BDP 220 is address MBAddrO (corresponding to address 222-1 in FIG. 2) which points to free memory block 252 corresponding to DAT0 in FIG. 2, and also includes a next free memory block address NXT=MBAddr1 pointing to the next free memory block address of the given data packet for memory block 220 located at MBAddr1. The second address MBAddr1 (corresponding to address 222-2 in FIG. 2) points to free memory block 250 containing second data DAT1 and next address NXT=MBAdd2. The third address listed in memory block 220 of MBAddr2 points to free memory block 268 containing third data DAT2 and a next address NXT=MBAddr3. This process continues for all blocks until NXT=done is designated.

One embodiment of a computer memory allocation method can be viewed in conjunction with above description including the drawings and the hardware based memory allocation system 100 of FIG. 1. The method includes the steps of (1) receiving a request from a requestor for transferring data from a source 102 to a memory module 108 formatted with memory blocks, (2) transferring data from the source to the memory module according to instructions from the input controller 104, and (3) communicating a location of a free memory block in the memory module 108 according to a Block Descriptor Index (BDI) of Free List (FL) Addresses, each FL address pointing to a Block Descriptor Page (BDP) having a plurality of Memory Block (MB) addresses, each MB address pointing to a free memory block in the memory module 108, wherein the BDI and BDP are maintained by the block allocator 106 in communications with the input controller 104 and the output controller 110.

Each of the memory module 108, input controller 104, output controller 110 and block allocator 106 are hardware devices located within a computer system. The plurality of MB addresses of the BDP are assigned to free memory blocks in different memory channels in the memory module 108. The request for transferring data to the memory module is received by the input controller 104 which, in turn, notifies the block allocator 106 of the transfer request. The block allocator 106 sends one or more FL addresses of the BDI to the input controller 104. The data packet or other information to be transferred and received from the source 102 is then transferred via the input controller from the source 102 to the memory module 108 via the plurality of MB addresses associated with the BDP and the associated one or more FL addresses.

The input controller 104 transfers the data packet from the source 102 to the memory module 108, each MB address used for the transfer including a pointer to a next free memory block of the plurality of MB addresses until a final pointer designates a last block of the data packet being transferred.

Another embodiment of a computer memory allocation method includes the step of receiving, via the input controller, a request for transferring data from the memory module 108 to a destination 112 and notifying the output controller 110 of the request. The output controller 110 reads the memory blocks of the data packet to be read in the memory module 108, reassembles the data packet to be read when received from the read memory blocks, transfers the reassembled data packet to the destination 112, and sends the MB addresses of the transferred data packet to the block allocator 106, wherein the block allocator will add the MB addresses of the transferred data packet to the BDI of FL addresses. Alternately, the output controller 110 sends the MB addresses of the transferred data packet to the input controller 104 and sends a pointer indexing the MB addresses of the transferred data packet to the block allocator 108. Each memory block of the data packet to be read includes a pointer to a next memory block, until a final pointer designates a last memory block of the data packet being read.

While the invention has been shown and described with reference to specific embodiments, it should be understood by those skilled in the art that various changes in form and detail may be made without departing from the scope of the invention.

What is claimed is:

1. A hardware based memory allocation system in a computer, the system comprising:
a memory module formatted with memory blocks;
an input controller, in communication with the memory module and receiving a transfer request from a requestor, for transferring data from a source to the memory module;
an output controller, in communication with the memory module and the input controller, for transferring data from the memory module to a destination; and
a block allocator, in communication with the input controller and the output controller, for maintaining a Block Descriptor Index (BDI) of Free List (FL) Addresses, each FL address pointing to a Block Descriptor Page (BDP) having a plurality of Memory Block (MB) addresses, each MB address pointing to a free memory block in the memory module.

2. The hardware based memory allocation system of claim 1, wherein the plurality of MB addresses of the BDP are assigned to free memory blocks in different memory channels in the memory module.

3. The hardware based memory allocation system of claim 1, wherein: the input controller receives the transfer request for transferring data from the source to the memory module and notifies the block allocator of the transfer request; the block allocator sends one or more FL addresses of the BDI to the input controller; and the input controller transfers a data packet received from the source to the memory module via the plurality of MB addresses associated with the BDP and the associated one or more FL addresses.

4. The hardware based memory allocation system of claim 3 wherein, when the input controller transfers the data packet from the source to the memory module, each MB address used for the transfer includes a pointer to a next free memory block of the plurality of MB addresses until a final pointer designates a last block of the data packet being transferred.

5. The hardware based memory allocation system of claim 1, wherein: the input controller receives the request for transferring data from the memory module to the destination; the input controller notifies the output controller of the request; and the output controller reads the memory blocks of the data packet to be read in the memory module, reassembles the data packet to be read when received from the read memory blocks, and transfers the reassembled data packet to the destination, wherein the output controller is in communications with the block allocator and sends the MB addresses of the transferred data packet to the block allocator, the block allocator adding the MB addresses of the transferred data packet to the BDI of FL addresses.

6. The hardware based memory allocation system of claim 5, wherein each memory block of the data packet to be read includes a pointer to a next memory block, until a final pointer designates a last memory block of the data packet being read.

7. The hardware based memory allocation system of claim 1, wherein: the input controller receives the request for transferring data from the memory module to the destination; the input controller notifies the output controller of the request; and the output controller reads the memory blocks of the data packet to be read in the memory module, reassembles the data packet to be read when received from the read memory blocks, and transfers the reassembled data packet to the destination, wherein the output controller sends the MB addresses of the transferred data packet to the input controller and sends a pointer indexing the MB addresses of the transferred data packet to the block allocator.

8. The hardware based memory allocation system of claim 1, wherein the memory module comprises TSV, DRAM, SRAM or CAM memory.

9. A computer memory allocation method, comprising the steps of:
receiving a request from a requestor to transfer data from a source to a memory module formatted with memory blocks;
transferring data from the source to the memory module according to instructions from an input controller; and
communicating a location of a free memory block in the memory module according to a Block Descriptor Index (BDI) of Free List (FL) Addresses, each FL address pointing to a Block Descriptor Page (BDP) having a plurality of Memory Block (MB) addresses, each MB address pointing to a free memory block in the memory module, wherein the BDI and BDP are maintained by a block allocator in communications with the input controller and an output controller.

10. The computer memory allocation method of claim 9, wherein each of the memory module, input controller, output controller and block allocator are hardware devices located within a computer system.

11. The computer memory allocation method of claim 9, wherein the plurality of MB addresses of the BDP are assigned to free memory blocks in different memory channels in the memory module.

12. The computer memory allocation method of claim 9, further comprising receiving, via the input controller, the request for transferring data to the memory module and notifying the block allocator of the transfer request.

13. The computer memory allocation method of claim 12, further comprising sending, via the block allocator, one or more FL addresses of the BDI to the input controller.

14. The computer memory allocation method of claim 13, further comprising transferring, via the input controller, a data packet received from the source to the memory module via the plurality of MB addresses associated with the BDP and the associated one or more FL addresses.

15. The computer memory allocation method of claim 14, further comprising transferring, via the input controller, the data packet from the source to the memory module, each MB address used for the transfer including a pointer to a next free memory block of the plurality of MB addresses until a final pointer designates a last block of the data packet being transferred.

16. The computer memory allocation method of claim 9, further comprising receiving, via the input controller, a request for transferring data from the memory module to a destination and notifying the output controller of the request.

17. The computer memory allocation method of claim 16, further comprising reading, via the output controller, the memory blocks of the data packet to be read in the memory module, reassembling the data packet to be read when received from the read memory blocks, transferring the reassembled data packet to the destination, sending the MB addresses of the transferred data packet to the block allocator, and the block allocator adding the MB addresses of the transferred data packet to the BDI of FL addresses.

18. The computer memory allocation method of claim 17, wherein each memory block of the data packet to be read includes a pointer to a next memory block, until a final pointer designates a last memory block of the data packet being read.

19. The computer memory allocation method of claim 17, further comprising sending, via the output controller, the MB addresses of the transferred data packet to the input controller and sending a pointer indexing the MB addresses of the transferred data packet to the block allocator.

20. The computer memory allocation method of claim 9, wherein the memory module comprises TSV, DRAM, SRAM or CAM memory.
